(19) United States
(12) Patent Application Publication
(10) Pub. No.: US 2005/0141954 A1
(43) Pub. Date: Jun. 30, 2005

(54) Bearing bolt joint

(76) Inventors: Rolf Mieger, Kirchdorf (DE); Dirk Asam, Ulm (DE)

Correspondence Address: DILWORTH & BARRESE, LLP, 333 EARLE OVINGTON BLVD., UNIONDALE, NY, 11553, US

(21) Appl. No.: 10/962,037

(22) Filed: Oct. 8, 2004

(30) Foreign Application Priority Data
Oct. 8, 2003 (DE) UM 203 15 460.6

(51) Int. Cl. F16B 7/10

(52) U.S. Cl. 403/109.5

(57) ABSTRACT

The invention relates to a bearing bolt joint having a bolt and an arrangement to fix the bolt to a machine element, with the bolt having a cylindrical center part and two conically tapering ends and wherein the arrangement to fix the bolt consists of two inwardly conically extending expansion bushings which can be axially clamped by means of clamping means and which are expandable in the direction of the machine element in this process. In accordance with the invention, the expansion bushings each have a coupling region at their end pointing away from the bolt, with a pull-off tool being loosely connectable to said coupling region.

The invention relates to a bearing bolt joint in accordance with the preamble of claim 1.

Bearing bolt joints without clearance are already known which essentially consist of a bolt and an arrangement to fix the bolt to a machine element. The bolt has a cylindrical center part and two conically tapering end parts. The arrangement to fix the bolt consists of two inwardly conically extending expansion bushings which are axially clampable to the bolt by means of screws and washers and are thus seated without clearance in the receiving bore. With the fixed bearing, the support of a bolt in a bore must be provided with minimum clearance for reasons of assembling capability and disassembling capability. If the clearance is too large, on the one hand, the result is a fast knocking out of the bore. If, however, the clearance is too small, the assembly and disassembly is no longer ensured. In practice, it is in particular the disassembly which causes high costs.

To prevent the previously described knocking out, the initially described bearing bolt joints were developed and used in many areas of the construction machine industry. A description of such a bearing bolt joint already results from DE 690 11 330 T2.

The installation of these bushings is generally unproblematic; but it has been found that large problems occur on the dismantling under certain circumstances in that the cone-type bushings cannot be removed or can only be removed with difficulty. The reason for this can lie in the fact that worked support positions of the components cannot be completely protected against corrosion and a friction coefficient is thus adopted which makes a removal of the cone-type bushing much more difficult and sometimes even impossible. To eliminate this deficiency, holding bushings have already been developed which are connected to the required coupling nut in a shaped matched manner such that the expansion bushing can be clamped and also drawn again. The disadvantage of such a unit lies in the high price and in the greater space requirements. These are also the reasons why this type of bearing bolt joint was not able to establish itself on the market.

Starting from the aforesaid prior art, it is the underlying object of the present invention to provide a bearing bolt joint which can be built in a space-saving manner and which can be dismantled in a simple manner without any great additional costs.

This object is solved in accordance with the invention by the combination of the features of claim 1.

According to this, in a generic bearing bolt joint, the expansion bushings each have a coupling region at their end pointing away from the bolt, with a pull-off tool being releasably connectable to said coupling region. For the dismantling, the corresponding pull-off tool can here be connected to the expansion bushing and the latter can be drawn in a simple manner to release the bearing bolt joint.

Preferred aspects of the invention result from the dependent claims following the main claim. Accordingly, the coupling region can be made as an internal thread into which a pull-off screw or pull-off sleeve can be screwed. The material thickness is the largest particularly in the rear conical region in the expansion bushings. A corresponding internal thread, into which the pull-off screw or pull-off sleeve can be screwed, can therefore be made here without problem

When a pull-off sleeve is used, it can advantageously be partly or fully slotted. The unscrewing or screwing in of the pull-off sleeves is also hereby made possible with variable expansion bushing diameters which are caused by the pressing on of the expansion bushing.

In another advantageous embodiment, the coupling region is made as a grooved surface region, for example in a recess in the expansion bushing. A correspondingly shaped engagement region of the pull-off tool can be brought into engagement with this grooved surface region. The pull-off tool provided for an expansion bushing made in this manner can itself advantageously include an expandable sleeve with a conical internal diameter which can be expanded by means of a frusto-conical contact surface.

The expansion bushings can advantageously, as already known as such in the prior art, be slotted at their periphery.

Further details, advantages and features of the invention result from the embodiments shown by way of example in the drawing. There are shown:

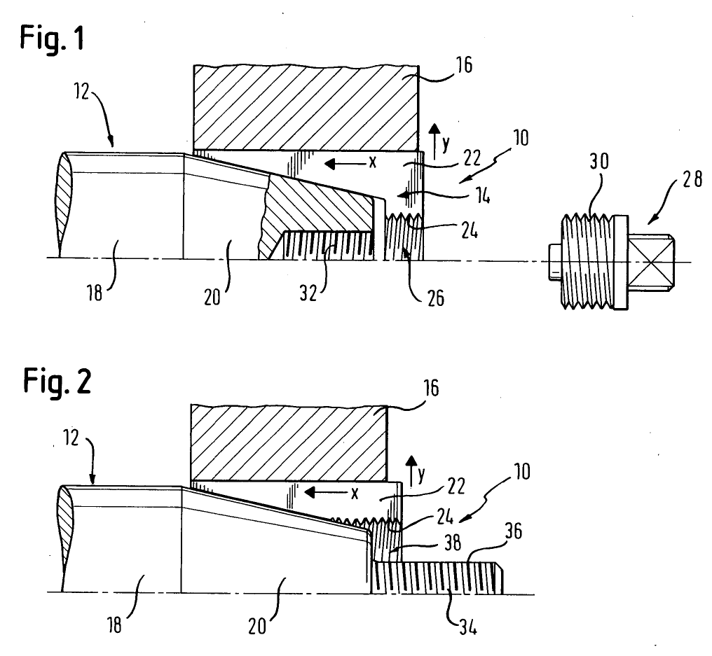

FIG. 1: a partial section through a bearing bolt joint in accordance with a first embodiment of the present invention;

FIG. 2: a representation in accordance with FIG. 1 of a second embodiment;

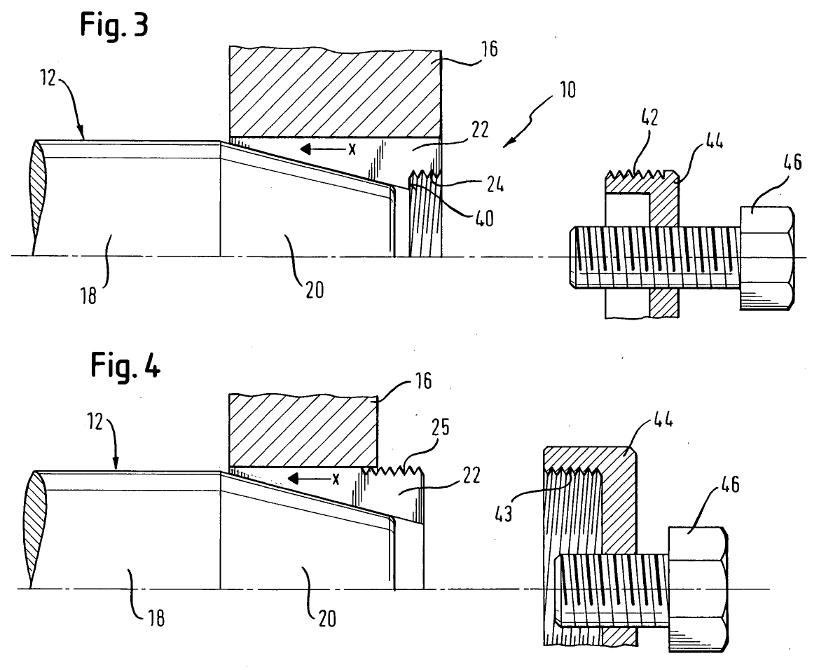

FIG. 3: a representation corresponding to FIG. 1 of a third embodiment;

FIG. 4: a representation corresponding to FIG. 1 of a fourth embodiment;

FIG. 5: a representation corresponding to FIG. 1 of a fifth embodiment; and

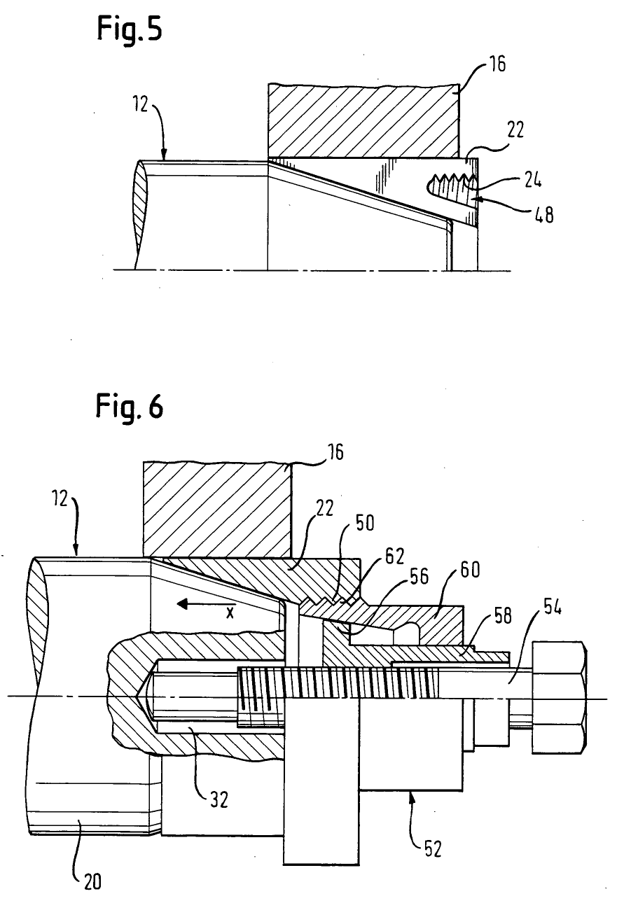

FIG. 6: a sixth embodiment variant of the present invention corresponding to an embodiment represented in FIG. 1.

A bearing bolt joint 10 in accordance with the invention is shown in FIG. 1 in accordance with a first embodiment of the invention in which a bolt 12 is fixed in a machine element 16 by means of an arrangement to fix the bolt 14. The bolt has a cylindrical center part 18 and two conically tapering ends 20 of which one end is shown in FIG. 1. Of the arrangement to fix the bolt, one of the two expansion bushings 22 is shown here which are displaceable in the arrow direction x by means of clamping means not shown in any more detail here. The expansion bushings 22 expand outwardly in the direction of the arrow y along the conically tapering ends 20 of the bolt 12 such that a fixed seating with the machine element 16 is ensured here.

The expansion bushing 22 has a coupling region 26 made as an internal thread 24 at the end pointing away from the bolt 12 and a pull-off sleeve which serves as a pull-off tool 28 and which has a corresponding external thread 30 can be screwed into said coupling region 26 such that the expansion bushing 22 is movable against the arrow direction x with the help of this sleeve so that it is drawn together and can be moved out of the fixed engagement with the machine element 16.

Slots are arranged in a manner not shown in any more detail here at the outer periphery of the pull-off sleeve 28 and permit a reduction in the outer periphery of the pull-off sleeve. The external diameter of the pull-off sleeve can hereby be adapted to the optionally varying internal diameter of the internal thread 24. A blind hole with an internal thread 32 is turned into the end of the bolt 12 and a screw can be screwed into it via which the expansion bushing 22 can be pushed in the x direction onto the conically tapering end 20 of the bolt by means of suitable screws and washers.

The embodiment shown in FIG. 2 corresponds in substantial parts to that in accordance with FIG. 1. For reasons of simple representation, like parts are shown with like reference numerals here.

Instead of the blind hole bore 32 with an internal thread, here a screw bolt 34 with an external thread 36 is provided onto which the nuts and washers for the clamping of the expansion bushing 22 can be pulled or screwed. Due to this design difference, a lateral, central opening 38 is provided in the expansion bushing 22 and the threaded bolt 36 can project outwardly through it. The internal diameter of the internal screw connection 24 is, in accordance with the opening 38, comparatively larger than that in the embodiment in accordance with FIG. 1. A pull-off sleeve not shown in any more detail in FIG. 2 engages into this in the same way as shown in FIG. 1.

The embodiment in accordance with FIG. 3 essentially corresponds to that in accordance with FIG. 2, with here no bolt with thread being provided which projects outwardly. A shoulder 40 is formed inside the expansion bushing 22 here, with the internal thread being turned in in the region of the shoulder 40. The external thread 42 of a sleeve 44 in which a pressing screw 46 is rotatably supported can be screwed into this internal thread. The expansion bushing 22 is then drawn counter to the arrow direction x via the pressing screw 46 after a corresponding opening of the sleeve 44.

The embodiment in accordance with FIG. 4 corresponds to that in accordance with FIG. 3, with an external thread 25 being provided here at the expansion bushing 22 and with an internal thread 43 of the sleeve 44 being able to be screwed onto it. A pressing screw 46 is again provided here by means of which the expansion bushing 22 can be drawn corresponding to the arrow direction x.

FIG. 5 shows a variant in which an internal thread 24 is provided in a recess 48 inside the expansion bushing 22, with a pull-off tool being able to be used here to draw the expansion bushing such as is shown in FIG. 3.

Another embodiment is shown in FIG. 6. A pull-off tool 52 essentially consists of a screw 54 which can displace a sleeve 58 having a frusto-conical region 56 in the x direction such that a spreading-cone 60 which sits on the sleeve 58 and which has a conical inner surface contacting opposite the frusto-conical surface 56 can be moved radially outwardly. The outer surface of the spreading cone 60 likewise has grooves 62 which have the negative shape of the grooves 50 of the expansion bushing 22. The sleeve 58 can thus be displaced in the x direction by a corresponding rotation of the screw 54 and thus the spreading cone 60 can be expanded or drawn together so that the surface region with the grooves 62 can be brought into engagement with the corresponding surface region with the grooves 50 of the expansion bushing 22. After a corresponding engagement of the groove regions 62 and 50, the screw 54 is turned into the existing bore 32. At the same time, the sleeve 58 is displaced by means of the thread, whereby the expansion bushing 22 is pulled out.

1. A bearing bolt joint having a bolt and an arrangement to fix the bolt to a machine element, with the bolt having a cylindrical center part and two conically tapering ends and wherein the arrangement to fix the bolt consists of two inwardly conically extending expansion bushings which can be axially clamped by means of clamping means and which are expandable in the direction of the machine element in this process,
characterized in that
the expansion bushings each have a coupling region at their end pointing away from the bolt, with a pull-off tool being loosely connectable to said coupling region.

2. A bearing bolt joint in accordance with claim 1, wherein the coupling region is made as an internal thread into which a pull-off screw or a pull-off sleeve can be screwed.

3. A bearing bolt joint in accordance with claim 2, wherein the pull-off sleeve is partly or fully slotted.

4. A bearing bolt joint in accordance with claim 1, wherein the coupling region is made as a grooved surface region with which a pull-off tool can be brought into engagement.

5. A bearing bolt joint in accordance with claim 4, wherein the pull-off tool includes an expandable sleeve which has a conical internal diameter and which can be expanded by means of a frusto-conical contact surface.

6. A bearing bolt joint in accordance with claim 1, wherein the expansion bushings are slotted.

7. A bearing bolt joint in accordance with claim 2 any one of the preceding claims, wherein the expansion bushings are slotted.

8. A bearing bolt joint in accordance with claim 3 any one of the preceding claims, wherein the expansion bushings are slotted.

9. A bearing bolt joint in accordance with claim 4 any one of the preceding claims, wherein the expansion bushings are slotted.

10. A bearing bolt joint in accordance with claim 5 any one of the preceding claims, wherein the expansion bushings are slotted.
